(19) United States
(12) Patent Application Publication
(10) Pub. No.: US 2002/0030000 A1
(43) Pub. Date: Mar. 14, 2002

(54) Installation and process for sorting used batteries

(75) Inventors: Willem Antoon Van Peperzeel, Ermelo (NL); Huibert Jacobus Hendrik Van Deutekom, Veldhoven (NL)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: W.A. van Peperzeel B.V., Ermelo (NL)

(21) Appl. No.: 09/921,557

(22) Filed: Aug. 6, 2001

(30) Foreign Application Priority Data
Aug. 4, 2000 (NL) 1015880

(51) Int. Cl. B07C 7/04

(52) U.S. Cl. 209/630; 209/692; 209/705; 209/707; 209/933

(57) ABSTRACT

Apparatus and method for sorting used batteries, comprising an intake station, an outlet station and a pre-sorting station disposed between the intake station and the outlet station, which pre-sorting station connects to a first re-sorting station and a second re-sorting station. The two re-sorting stations are arranged for manual examination and removal of undesirable batteries and further objects, as well as for manual sorting of batteries and other objects that land in the re-sorting stations during operation of the apparatus.

### FIELD OF THE INVENTION

The invention relates to sorting techniques, and more in particular to an apparatus and a method for sorting used batteries.

### BACKGROUND OF THE INVENTION

Worldwide, batteries, among which accumulators, are used on a large scale and for various purposes. Well-known are the traditional lead-acid batteries as used in cars, for lighting purposes and for emergency power supply, as well as the generally known Leclanché batteries and other types of zinc-manganese dioxide batteries for flashlights, radios and other electronic equipment.

Partly due to the enormous growth in the use of electronic equipment, in particular portable telecommunication and sound equipment, the use of batteries has increased explosively over the past ten years.

Not only their use has developed, but also the insight that batteries, on account of their chemical composition, cannot be processed as common household waste in incinerators or at garbage dumps.

All this has induced people to pay more attention to the collection of used batteries, which also enables reuse of the raw materials that are used in the batteries, which can be very attractive from an economic viewpoint. In the case of lead-acid batteries, for example, the lead that is incorporated therein, which constitutes more than 65% of the dry battery (without acid), can readily be reused.

Batteries can be roughly divided into two groups, viz. industrial batteries and consumer batteries.

Industrial batteries are for the major part batteries (rechargeable batteries) of large dimensions and varying, mainly prismatic shape, zinc-manganese dioxide batteries for grassland fencing and obstacle illumination and, among other types, lithium ion batteries for special applications. In this connection reference can be made to International Standards IEC 60095, 60254, 60622, 60623, 60896, 60952, 61056 and 61427.

The group of consumer batteries comprises for the major part small, disposable, non-rechargeable (primary) batteries, and smaller, rechargeable (secondary) batteries in a limited number of types as regards their shape, among which circular-cylindrical and prismatic. Reference can be made to International Standards IEC 60086, 60285, 61463, 61440 and 61808. This group of batteries is also called “portable batteries” in English literature, as “Gerätebatterien” in German and as “piles” in French. Well-known type indications are “R20”, “Mono”, “R6”, “Mignon”, “AA”, “AM3”, “PP8”, “baby”, “micro” and other designations.

For the major part, the group of consumer batteries consists of zinc-manganese dioxide batteries in the electrochemical systems of Leclanché and Alkaline. The term electrochemical systems is understood to refer to the types of materials that are used in the battery, that is, the metals and the chemicals that are used. A smaller portion of the consumer batteries consists of a multitude of electrochemical systems of highly diverse composition, among which nickel-cadmium batteries, lead-acid batteries, nickel-metal hydride batteries, zinc-manganese dioxide batteries, lithium ion batteries and other types of batteries.

From European patent application EP 0 761 311 there is known an apparatus for sorting used batteries, comprising a intake station, an outlet station and a pre-sorting station disposed between the intake station and the outlet station, which pre-sorting station connects to a first re-sorting station. The sorting of batteries takes place by means of optimal image analysis. To this end it is necessary to separate the prismatic batteries from the circular-cylindrical batteries, and each battery must be individually subjected to an identification step, which varies according to the shape and the dimensions of the batteries in question.

To this end, the circular-cylindrical consumer batteries are received in a rotating drum screen, which consists of chambers having openings of varying size. Depending on the size of the opening of a respective chamber, the various batteries are separated according to size and collected in a suitable collecting container. The batteries thus collected are then sorted by means of optical image analysis and divided into classes of similar batteries. The prismatic batteries, among which the group of industrial batteries, are collected as a whole in a collecting container for prismatic batteries.

The separation of batteries according to their shape, which is necessary to enable optical identification, is a costly process. Furthermore it has become apparent that, in particular with regard to the industrial or prismatic batteries, optical image processing as proposed by the aforesaid European patent application, does not produce satisfactory results in practice, partly due to the great diversity in the group of industrial and prismatic batteries. Accordingly, the sorting technique proposed in EP 0 761 311 is limited to substantially round or circular-cylindrical consumer batteries.

In practice various other techniques are known for sorting or separating collected, used batteries into a fraction which is suitable for being processed.

International patent application WO 91/15036 relates to a measurement device and a method for sorting used batteries on the basis of their chemical composition. The measurement device is based on the analysis of the inductive effect produced by the substances contained in the battery upon excitation with an alternating electric field, and whose ferromagnetic properties vary according to their chemical constitution. Use is made of an excitation circuit of at least two different voltage amplitudes at the same frequency or two different frequencies.

International patent application WO 94/25992 relates to a sorting method, wherein the used batteries are sorted on the basis of their size, their weight and, for example, the colour of their housing. For each type of battery or accumulator, a characteristic combination of the aforesaid parameters is established, on the basis of which the sorting process is carried out.

International patent application WO 96/35522 relates to the sorting of used batteries on the basis of measured electrical properties of the battery. To this end, a varying electrical voltage is applied to a battery in question, for example a first pulse and a second pulse which have opposite polarities. In addition, an additional property of a respective battery is determined, such as the shape or the colour of the battery. Based on the measured electrical properties and the aforesaid additional characteristic, a separation according to the type of electrochemical system can be carried out.

International patent application WO 94/19838 discloses a technique for sorting used batteries through the application of magnetic fields.

German patent application DE-A-4.334.714 and international patent application WO 92/17791 disclose a sorting system for used batteries, comprising a sorting station which includes vibrating tables for screening the batteries being supplied into different fractions.

All of the above sorting techniques have the aforesaid drawback as regards cost, viz. the fact that each battery must be separated and identified individually, after which the fractions thus obtained must be put together again on the basis of their electrochemical system.

It has become apparent in practice that hazardous substances can be released from used or disposed batteries when the batteries in question are subjected to strong mechanical movement, for example during a screening process. Said mechanical movement can lead to a short-circuit in the battery, among other things, whereby the battery can heat up strongly in some cases, which may lead to fire and explosion.

Furthermore it has become apparent that collected consumer batteries, for example, are generally also mixed with industrial batteries, among which batteries used for military or naval or other professional purposes. It cannot be excluded that the excitation of these batteries, either by induction or electrically, can involve certain safety hazards.

Consequently, measures need to be taken against fire, explosion and/or leakage, for example covering the batteries with sand from (automatic) sanders, bins and the like.

In addition, the batteries may be damaged, as a result of which electric excitation of the batteries, for example, for the purpose of establishing the type of battery, is not possible.

### SUMMARY OF THE INVENTION

It is an object of the invention to provide an improved apparatus for sorting used batteries, by means of which the above-described drawbacks of the known apparatuses are overcome in an effective manner and by means of which a high handling rate can be achieved whilst retaining a very high quality of the sorting fractions, such as required for further processing thereof, and a high degree of flexibility, in order to be able to anticipate the quick changes in the recycling technology and the relevant legislation.

According to the invention this objective is accomplished in that the pre-sorting station furthermore connects to a second re-sorting station, wherein the two re-sorting stations are arranged for the manual examination and removal of undesirable batteries and further objects, as well as for the manual sorting of batteries and other objects that land in the re-sorting stations during operation.

The invention is based on the insight that one or more re-sorting steps will be indispensable at all times and under all circumstances in order to achieve a reliable and efficient sorting or examination of batteries. This goes for the group of consumer batteries, but in particular also for the group of prismatic and industrial batteries, among which the “battery-packs” of, for example, portable telephones, computers, video recorders and camcorders and other portable electronic equipment, among which also batteries for professional use, which contain cadmium and which may involve special hazards in that they contain hazardous materials such as thionyl chloride, sulphoryl chloride, phosphoryl chloride and sulphur dioxide under high pressure.

Manual examination and sorting according to the present invention can best be defined as a collective sorting technique, in contrast to the above-discussed automatic sorting processes, wherein each battery must be individually identified and classified. In the case of homogeneous, to a certain extent, batches of batteries to be sorted, the examination and sorting process can substantially be limited to the identification and removal of undesirable batteries and objects when using the collective technique according to the invention, whilst each battery and each object will have to be identified individually when the automatic sorting techniques are used. It will be understood that it is possible in such a case, using the collective technique according to the invention, to achieve a significantly larger throughput than with the automatic techniques whilst a limited number of human examiners or sorters are required.

In a preferred embodiment of the invention, the pre-sorting station comprises a sloping conveyor belt having a conveying surface which moves from a lower end to an upper end during operation for the purpose of sorting batteries under the influence of the force of gravity, wherein the upper end of the sloping conveyor belt connects to the first re-sorting station, which comprises a first re-sorting conveyor belt, and wherein the lower end of the sloping conveyor belt connects to the second re-sorting station, which comprises a second re-sorting conveyor belt, which re-sorting conveyor belts are arranged for the manual examination and removal of undesirable batteries and further objects, as well as for the manual sorting of batteries and further objects that land on said re-sorting conveyor belts during operation.

It has been found that the manual examination and sorting of the batteries and other objects is to a large extent dependent on their shape. The use of a sorting station fitted with a sloping conveyor belt makes it possible to effect a separation between the aforesaid groups of industrial and prismatic batteries and round or circular cylindrical consumer batteries, such that an adequate handling rate is achieved with the manual examination and sorting steps.

After all, the circular cylindrical consumer batteries, which make up the larger part of the used batteries, will roll downwards over the sloping conveyor belt to the lower end thereof under the influence of the force of gravity, and land on the second re-sorting conveyor belt. The moving, sloping conveyor belt will carry batteries having shapes other than circular cylindrical or prismatic to the upper end of the conveyor belt, where they will land on the first re-sorting conveyor belt.

As a result of the separation that is thus mechanically effected, the amount of manpower required for re-sorting the batteries can be efficiently geared to the amounts of used batteries to be handled, the examination rate of the various batteries (round versus prismatic) and the present and future (legal) requirements that are (will be) made with regard to the processing of the batteries in question, anywhere in the world and geared to existing and future recycling processes.

Besides a further separation of the batteries according to their electrochemical system, the lower (or second) re-sorting conveyor belt enables the effective removal of other objects, in particular round sensors, capacitors and, for example, round or circular cylindrical ammunition and firework, which may be present as foreign matter among the batteries.

Not only the types of batteries that are not circular cylindrical or prismatic land on the first, or upper, re-sorting conveyor belt, but also a small number of round batteries, of course, which have incorrectly been carried up by the sloping conveyor belt, for example as a result of the batteries being damaged or extremely soiled. Furthermore, also objects other than batteries will land on the first re-sorting conveyor belt, of course, which objects have been collected along with the batteries. Manual examination makes it possible to identify said objects quickly and handle them adequately.

For both re-sorting conveyor belts it obtains that the entire sorting process can be carried out therewith at a very high quality level as regards the separation according to heavy metals, valuable raw materials, such as cobalt or rare earths, and foreign matter in the form of objects other than batteries, such as medical waste, in particular injection needles and syringes, coins, cosmetics, sensors for oxygen, hydrogen and other gases, capacitors, in particular PCB-containing capacitors, ink cartridges and cartridges of electronic printers, watches, electric toothbrushes, mixers, clocks, transformers, electronic components, medicines, nails, life buoys fitted with active smoke generators, packaged batteries, disposed batteries in bags and boxes and further objects that are collected along with the used batteries.

It has been found that the apparatus according to the invention, unlike the automatic sorting apparatuses that are known from the prior art, makes it possible to achieve such a high sorting accuracy that the batteries that have been sorted according to their electrochemical properties can be directly presented to recycling plants and companies. It will be understood that this forms an important element in controlling the costs of the overall processing of used batteries.

Furthermore it has been found in practice that the apparatus according to the invention makes it possible to achieve optimum results if the sloping conveyor belt is disposed at an angle of 15-35 degrees to a horizontal plane, in particular at an angle of inclination of 21.5 degrees.

It will be understood that the velocity at which the sloping conveyor belt moves during sorting operation has an effect on the quantity and the quality of the sorting result. If the belt moves too quickly, the batteries that roll down under the influence of the force of gravity will be present on the conveying surface of the sloping conveyor belt for a longer period of time, which has a negative effect on the handling capacity of the apparatus. In that case there is even an increased risk of the batteries in question being undesirably carried along by the sloping conveyor belt to the upper end thereof.

On the other hand, when the sloping conveyor belt moves too slowly, there is also a danger of batteries other than circular cylindrical ones, for example, moving down over the conveying surface under the influence of the force of gravity, or of said batteries remaining present on the conveying surface too long, which also has a negative effect on the handling capacity of the apparatus.

It has become apparent that the sloping conveyor belt has to move at a velocity of about 0.6-1 m/sec for sorting operation. In the preferred embodiment of the invention, a velocity of 0.8 m/sec is used.

In addition to the angle of inclination and the carrying velocity, also the profile and the roughness of the sloping conveyor belt influence the intended sorting effect.

The preferred embodiment of the invention uses a sloping conveyor belt whose conveying surface has a “Rufftop” or “supergrip” profile, type 2R sg-0 FS, which prevents undesirable movement over the sloping conveyor belt of batteries other than circular cylindrical ones, also in the case of soiling. One characteristic of a profile of this kind is that it prevents the batteries sticking together, that it enables an adequate sorting effect in the case of soiled batteries, and that its rebouncing effect on batteries landing on the belt is small.

In practice, the collected batteries are frequently soiled with oil residue and sand, sludge and leakage water and rain water, among other substances. It will be understood that such foreign matter affects the velocity at which the batteries move over the sloping surface or the sloping conveyor belt. Oil residue, which makes the collected batteries slippery, reduces the friction between the conveying surface and the battery, so that far more batteries than desirable will move down over the sloping conveying surface.

Although the conveying surface of the sloping conveyor belt may consist of various materials, a preferred embodiment of the invention is characterized in that the sloping conveyor belt, or the conveying surface thereof, consists of two layers of reinforced polyester. This material is sufficiently resistant against oil and organic contaminants, acids, lyes and salts of batteries, sand, sludge, rain water and other contaminated water.

It is possible, by means of an additional automatic sorting operation, to carry out a further sorting operation on the first and/or the second re-sorting conveyor belt, so as to further speed up and perfect the final sorting result. Automatic examination or sampling of the batteries and further objects on the re-sorting conveyor belts can take place by means of systems for automatic visual recognition of objects or for identifying batteries by electric means, as described above in connection with the prior art.

In another embodiment of the apparatus according to the invention, a re-screening separator, such as a bar grizzly, is disposed between the upper end of the sloping conveyor belt and the first re-sorting conveyor belt, by means of which the small percentage of round or circular cylindrical batteries that are carried upwards by the sloping belt are separated from the prismatic batteries. That is, the round or circular cylindrical batteries are collected in a collecting container intended for that purpose, whilst the prismatic batteries, and other objects, of course, land on the first re-sorting conveyor belt. The collected round or circular cylindrical batteries can be returned to the intake station, manually and/or via a system of chutes, for the purpose of being sorted anew by means of the sloping conveyor belt.

If the amount of foreign objects in a collected batch of used batteries is too large, or if the batch is soiled with oil and/or water or other substances to such an extent that the batteries cannot be placed on the sloping conveyor belt any more, for example because the batteries stick together, or if the batteries cannot be examined any more, for example as a consequence of being soiled with toner from printer cartridges, such a batch is unsuitable for further sorting.

In the preferred embodiment of the apparatus according to the invention, various examination and sorting stations are incorporated between the intake station and the outlet station for the purpose of separating batteries and further objects that do no fall within the set specifications.

In a further embodiment of the apparatus according to the invention, in order to be able to evaluate the suitability of a collected batch of used batteries, the pre-sorting station comprises a pre-sorting conveyor belt disposed between the intake station and the sloping conveyor belt, which pre-sorting conveyor belt is arranged for manual examination and removal of undesirable batteries and further objects that land on the pre-sorting conveyor belt during operation. The objects on the pre-sorting belt can be additionally examined or sampled by automatic sampling means, if desired. All this as explained above in connection with the first and the second re-sorting conveyor belt.

In an embodiment of the apparatus according to the invention which is advantageous in practice, the pre-sorting conveyor belt is disposed in such a manner that it discharges onto the sloping conveyor belt near the upper end thereof. By removing the foreign objects, that is, those objects that are not batteries, and the undesirable batteries from the pre-sorting conveyor belt, only batteries, in the main, will eventually be transported from the pre-sorting conveyor belt to the sloping conveyor belt and be subjected to the pre-sorting process on the sloping conveyor belt under the influence of the force of gravity.

It has become apparent that an optimum, efficient handling rate and handling capacity is achieved with the apparatus according to the invention when the pre-sorting conveyor belt connects to the sloping conveyor belt at about ¼ the length of the sloping conveyor belt, seen from the upper end thereof.

Preferably, the pre-sorting conveyor belt is made of a smooth plastic material so as to enable adequate automatic removal of soiling substances such as oil, sand, sludge from the belt. A suitable material for the pre-sorting conveyor belt is PVC. A third discharge sub-station is provided for discharging the foreign objects that have been sorted out.

PVC has a coefficient of friction which helps the batteries to remain stationary while the belt is moving, so as to facilitate manual sorting or examination, and which furthermore facilitates the automatic examination and removal (“picking”) of the batteries. PVC is an anti-static material, which helps to prevent the spreading of dust, which is important in connection with preventing the spreading of mercury and other substances that can be harmful. PVC can be supplied in the colour green, which is pleasant to the eye in connection with the manual examination of batteries on the pre-sorting conveyor belt.

In a preferred embodiment of the invention, the pre-sorting conveyor belt, the sloping conveyor belt and the first and the second re-sorting conveyor belt are disposed high above a workshop floor. In particular in such a manner that it is possible to place so-called “big bags”, among other containers, at the first and the second re-sorting conveyor belt as well as at the pre-sorting conveyor belt, for directly supplying the sorted batteries from the respective conveyor belts thereto and for discharging the foreign objects and other foreign matter that is removed from the pre-sorting belt and the first and the second re-sorting conveyor belt during examination. Preferably, the conveyor belts in question are disposed at such a height that sufficient space is created for using fork-lift trucks and the like to enable easy removal of the big bags or other containers in which the sorted batteries and foreign objects are collected.

An embodiment of the invention comprises a so-called Jacob's ladder for transporting the collected, used batteries from an intake station disposed on a workshop floor and the pre-sorting conveyor belt, which is disposed at a higher level, which Jacob's ladder consists, for example, of a conveyor belt with an accordion belt on the sides, in which vertical partitions are provided for moving the collected batteries to the pre-sorting conveyor belt in metered amounts.

The use of said Jacob's ladder results in a suitable metering of the collected batteries and foreign objects, thus enabling an efficient examination on the pre-sorting belt. Preferably, the partitions of the accordion belt are adjustable so as to make it possible to adjust the amount of objects being supplied to the pre-sorting conveyor belt, for example when more or fewer examiners are available for manual examination.

In another preferred embodiment of the invention, the conveyor belt of said Jacob's ladder connects to a collecting container which functions to receive foreign adhering to the conveyor belt during the return movement thereof. The belt is automatically cleared of dust and residual dirt during its return movement. A high degree of self-cleaning is obtained by providing the conveyor belt of said Jacob's ladder with a smooth conveying surface.

In a practical embodiment, said Jacob's ladder is filled from a filling hopper provided with an adjustable metering plant and a dust separator, which preferably separates small objects, such as coin cells, as well.

The invention furthermore relates to a method for sorting used batteries by means of an apparatus comprising an intake station, an outlet station and a pre-sorting station disposed between the intake station and the outlet station, which pre-sorting station connects to a first re-sorting station, characterized in that said pre-sorting station furthermore connects to a second re-sorting station, wherein batteries and further objects that land in the two re-sorting stations during operation are examined, wherein the undesirable batteries and said further objects are manually removed and wherein the other batteries that land in the re-sorting stations are manually sorted.

The invention will now be explained in more detail by means of a few embodiments, without being limited thereto, however.

### BRIEF DESCRIPTION OF THE DRAWINGS

FIG. 1 is a schematic sectional view of a first, relatively simple embodiment of a pre-sorting station used in the apparatus according to the invention.

FIG. 2 is a schematic sectional view of a preferred embodiment of the apparatus according to the invention.

FIG. 3 is a schematic top plan view of an alternative arrangement of the preferred embodiment of the apparatus according to the invention.

### DETAILED DESCRIPTION OF THE EMBODIMENTS

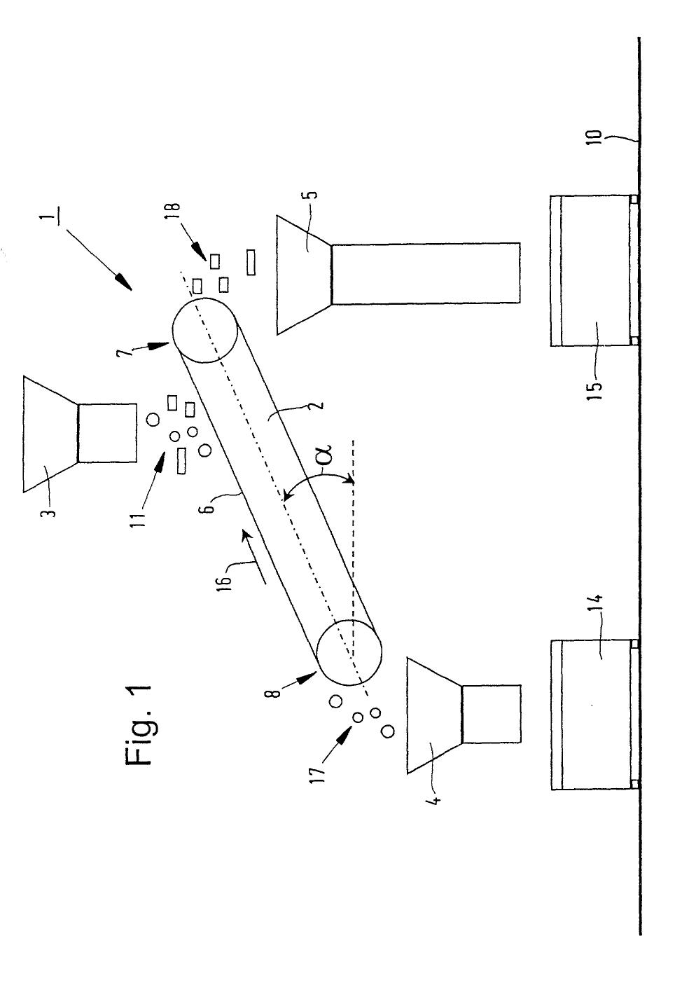

In FIG. 1, the pre-sorting station for use in the apparatus according to the invention, which is indicated as a whole by numeral 1, comprises a sloping conveyor belt 2, an intake station 3 and an outlet station consisting of a first sub-outlet station 4 and a second sub-outlet station 5.

Intake station 3 and outlet stations 4, 5 are schematically represented in the drawing in the form of hoppers having a wide filling opening and a narrowed outlet.

Intake station 3 is disposed in such a manner that its outlet discharges near the upper end 7 of sloping conveyor belt 2, seen in relation to the workshop floor 10, in such a manner that the collected batteries and other objects 11 will land onto conveying surface 6 of sloping conveyor belt 2 from the outlet of intake station 3, as is schematically illustrated.

The filling opening of the first sub-outlet station 4 is positioned near the lower end 8 of sloping conveyor belt 2, whilst the outlet thereof discharges into a first collecting container 14.

The filling opening of the second sub-outlet station 5 is positioned near the upper end 7 of sloping conveyor belt 2, whilst the outlet thereof discharges into a second collecting container 15. The operation of the pre-sorting station is as follows.

During operation, the sloping conveyor belt 2 is driven in such a manner that the conveying surface 6 thereof moves from the lower end to the upper end, as is indicated by arrow 16.

Of the collected batteries and other objects 11 that are deposited onto the conveying surface 6 of the sloping conveyor belt 2 from intake station 3, those having round and circular cylindrical shapes 17 will be moved towards the lower end 8 of the sloping conveyor belt 2 over the conveying surface 6 under the influence of the force of gravity and be collected in the first sub-outlet station 4 or in the first collecting container 14. Objects whose shape is not round or circular cylindrical, hereinafter generally indicated as prismatic shapes 18, will be carried to the upper end 7 of sloping conveyor belt 2 on the conveying surface 6 thereof and land in the second sub-outlet station 5 or in the second collecting container 15. The reason for this is that the angle of inclination a with a horizontal surface, such as workshop floor 10, and the velocity of movement of conveying surface 6 of the sloping conveyor belt 2, as well as the roughness and the profile of the conveying 6 are geared to each other in such a manner that the round or circular cylindrical shapes 17 will roll over the conveying surface 6 towards the lower end 8 of the sloping conveyor belt 2 under the influence of the force of gravity and the prismatic shapes 18 will remain on conveying surface 6 or move down less quickly under the influence of the force of gravity than the circular cylindrical shapes 17, so that said prismatic shapes 18 will be carried to the upper end 7 of the sloping conveyor belt 2.

Consequently, a separation between batteries and other objects 17 having round or circular cylindrical shapes and batteries and other objects having prismatic shapes 18 is effected.

Since the group of consumer batteries, as already set forth is in the introduction, generally consists of round or circular cylindrical shapes in the electrochemical systems of Leclanché and Alkaline, and the group of industrial batteries generally has square, rectangular or other shapes which are not round or circular cylindrical, the pre-sorting station not only provides a first sorting between consumer batteries and industrial batteries, but also a sorting according to the electrochemical system, that is, Leclanché and Alkaline and the other electrochemical systems.

In a preferred embodiment of the apparatus according to the invention, the sloping conveyor belt 2 is disposed at an angle α of 21.5 degrees, and the belt velocity is 0.8 m/sec. The conveying surface has a “Rufftop” of “supergrip” profile, type 2R sg-0 FS.

In general it can be stated that the velocity of the sloping conveyor belt 2 must range between 0.6-1 m/sec, and that the angle of inclination a may vary between 15-35 degrees. All this depending on the profile and the roughness of the conveying surface 6 of the sloping conveyor belt 2, of course.

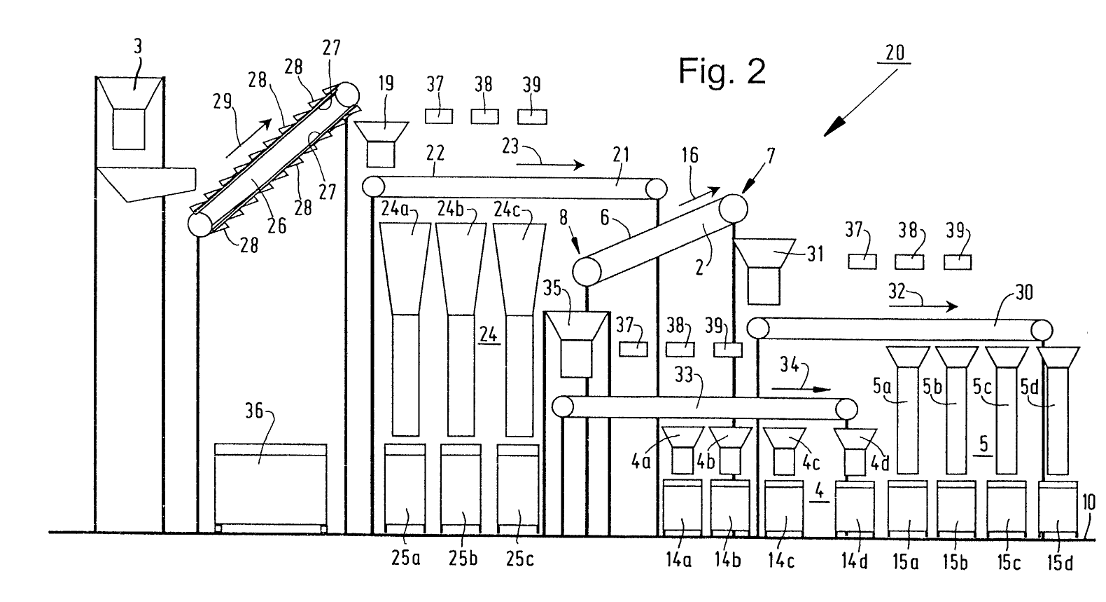

FIG. 2 schematically shows in sectional view a preferred embodiment of the apparatus according to the invention, as a whole indicated by numeral 20. Those parts that have the same function or a similar function as parts shown and described with reference to FIG. 1 are indicated by the same numerals in FIG. 2.

Disposed between the sloping conveyor belt 2 of pre-sorting station 1 and the intake station 3 is a pre-sorting conveyor belt 21, whose conveying surface 22 is moved in the direction of sloping conveyor belt 2, as indicated by arrow 23. In this preferred embodiment, the pre-sorting conveyor belt 21 is horizontally disposed at a higher level with respect to the workshop floor 10.

Disposed near the pre-sorting conveyor belt 21 is a third sub-outlet station 24, which consists of a number of receiving hoppers 24a, 24b, 24c, which discharge into collecting containers 25a, 25b and 25c, respectively. Pre-sorting conveyor belt 21 is disposed at such a height that so-called “big bags” can be used as the collecting containers 25a, 25b, 25c, and that there is sufficient manoeuvring space available for a fork-lift truck, for example. In a practical embodiment of the installation, six receiving hoppers 24 and associated collecting containers 25 are provided.

In the illustrated embodiment, a so-called Jacob's ladder is present between the pre-sorting conveyor belt 21 and the intake station 3.

Jacob's ladder 26 in fact consists of a conveyor belt with an accordion belt 27 on the sides, in which vertical partitions 28 are provided for taking the collected, used batteries in metered amounts from the intake station 3 to the pre-sorting conveyor belt 21, as is indicated by means of arrow 29. By using loose partitions 28, the metering of the amount of collected batteries being conveyed can readily be set. Intake station 3 preferably comprises an adjustable metering plant and a dust separator (not shown), which also separates small objects, such as coin cells.

Pre-sorting conveyor belt 21 discharges onto or above the sloping conveyor belt 2, at about ¼ the length of the sloping conveyor belt 2, seen from the upper end 7 thereof.

A first re-sorting conveyor belt 30 connects to the upper end 7 of sloping conveyor belt 2 via a second receiving hopper 31, which re-sorting conveyor belt moves in the direction of arrow 32 and discharges into or connects to the second sub-outlet station 5, which can consist of a number of receiving hoppers 5a, 5b, 5c, 5d in the illustrated embodiment, as can third sub-outlet station 24, which receiving hoppers discharge into collecting containers 15a, 15b, 15c, 15, for which purpose big bags may be used again. In one practical embodiment, the installation according to the invention comprises five receiving hoppers 5 and associated collecting containers 15.

The lower end 8 of the sloping conveyor belt discharges, via a third receiving hopper 35, onto a second re-sorting conveyor belt 33, which moves in the direction of arrow 34 and which in turn connects to first sub-outlet station 4 consisting of a number of receiving hoppers 4a, 4b, 4c, 4d and associated collecting containers 14a, 14b, 14c, 14d. In one practical embodiment of the installation according to the invention, six receiving hoppers 4 and associated collecting containers 14 are provided. The first and the second re-sorting conveyor belts 30, 33 are disposed horizontally with respect to floor 10. The operation of apparatus 20 is as follows.

The collected, used batteries and other objects and/or dirt are supplied from intake station 3 to Jacob's ladder 26, which supplies the collected, used batteries and other objects to the pre-sorting conveyor belt 21 via a first receiving hopper 19.

Jacob's ladder 26 is constructed in such a manner that dust and residual dirt present between the collected batteries and other objects are automatically removed from the belt during the return movement thereof. The conveyor belt of the Jacob's ladder 26 preferably has a smooth surface, which, in combination with the use of loose partitions 28 in accordion belt 27, makes the Jacob's ladder 26 self-cleaning to a high degree. That is, dirt that remains behind on the conveyor belt is discharged to a dust separator 26 during the return movement, whereby the coarse dust falls into a dustbin and is mechanically discharged.

Dust and dirt form a serious problems in the sorting of waste batteries. By using Jacob's ladder 26, the batteries are subjected to a first dust separation already, which is advantageous in connection with the further sorting operations.

The batteries and other objects that land on pre-sorting conveyor belt 21 are subjected to a first coarse separation thereon, wherein the larger batteries that are undesirable for being handled via the sloping conveyor belt and the re-sorting conveyor belts, such as the so-called grassland fencing batteries and other large batteries, as well as large foreign objects, are manually removed from the collected batteries and discharged via the third sub-outlet station 24. The various receiving hoppers 24a, 24b, 24c of the third sub-outlet station 24 are preferably arranged for discharging a specific type of product, such as grassland fencing batteries, packaged batteries, flat 4.5 V batteries, other foreign objects, etc.

The additional automated pre-sorting process can take place by means of video cameras 37, for example, or other detection equipment 38 for identifying objects in a manner which is known per se, which objects can subsequently be removed from the pre-sorting conveyor belt 21 by means of mechanical equipment 39. Specific identification of the undesirable larger batteries and other objects can take place on the basis of the known labels of the batteries in question and, for example, by electric detection through excitation of the batteries. Since it will not be necessary to explain the above means in more detail to those skilled in the art, they are only schematically indicated in FIG. 2.

Pre-sorting conveyor belt 21 is preferably made of a smooth PVC material so as to make it possible to clean the belt automatically to a sufficient degree by means of the facilities (not shown) that are provided for this purpose. The colour of the belt is preferably green, with a view to creating a muted examination background in the case of manual examination or pre-sorting. It is advantageous thereby that water that may be present on the batteries, which may lead to a film of moisture on the conveying surface of the belt, does not affect the green colour, so that it will not have a negative effect on the quality of the examination. The coefficient of friction of PVC is about 0.35, as a result of which the batteries will remain stationary while the belt is moving, which is advantageous both for manual examination and for automatic examination, which facilitates the removal of batteries from the belt (“picking”) both manually and automatically. Furthermore, PVC is an anti-static material, which helps to prevent the spreading of dust, in particular the spreading of substances which involve safety hazards, such as mercury.

Via pre-sorting conveyor belt 21, the batteries and the other objects that are finally pre-sorted land on sloping conveyor belt 2 of pre-sorting station 1, whose operation has already been described in detail with reference to FIG. 1.

The batteries having round and generally circular cylindrical shapes will land on the second, or low, re-sorting conveyor belt 33 via sloping conveyor belt 2. The prismatic batteries, for the major part rechargeable systems, such as nickel-cadmium batteries, nickel-metal hydride batteries, lead-acid batteries and lithium ion batteries, are carried along with the conveying surface 6 of the sloping conveyor belt to the first (or upper) re-sorting conveyor belt 30.

On the first (or upper) re-sorting conveyor belt 30, the prismatic batteries are manually sorted and identified according to their electrochemical system or origin or any other criterion. Also identified are the small number of round or circular cylindrical batteries that have been incorrectly carried along to the first re-sorting conveyor belt 30, as well as the other round objects, in particular capacitors and electrochemical parts that were not recognized and removed upon examination on the pre-sorting conveyor belt 21.

In this manner purposive recycling of the prismatic types of batteries at relatively low cost is made possible. The prismatic batteries in question can be collected separately by discharging them via a respective receiving hopper 5a, 5b, 5c, 5d of the second sub-outlet station.

Also in this case it obtains that the sorting or examination of the batteries and other objects on the first re-sorting conveyor belt 30, in combination with the manual step, can additionally also be carried out automatically, in the latter case by using means 37, 38, 39 as discussed in the foregoing in connection with pre-sorting conveyor belt 21.

The first and the second re-sorting conveyor belts are preferably made of a green PVC material.

In another embodiment of the apparatus according to the invention, the receiving hopper 31 is fitted with a bar grizzly or the like for mechanically screening round and circular cylindrical batteries that land on the first re-sorting conveyor belt 30 via sloping conveyor belt 2. The round or circular cylindrical batteries that have been separated in this re-screening step can be received in a further receiving bin and be returned either manually or via a system of chutes to intake station 3 for being sorted anew (not shown).

The round batteries are examined more closely on the second (or lower) re-sorting conveyor belt 33, and batteries of types other than zinc manganese dioxide batteries are identified. Said batteries are mainly nickel-cadmium batteries and nickel-metal hydride batteries, as well as a very small percentage of lithium ion batteries. In addition to this, the small number of batteries not having round or circular cylindrical shapes that have been incorrectly moved down to the first re-sorting conveyor belt 33 are identified, as are further objects, such as sensors, capacitors and ammunition that were not recognized and removed upon first examination on pre-sorting conveyor belt 21.

The sorting step on the second re-sorting conveyor belt 33 can additionally take place automatically as well in combination with the manual step, using the above-discussed means 37, 38, 39.

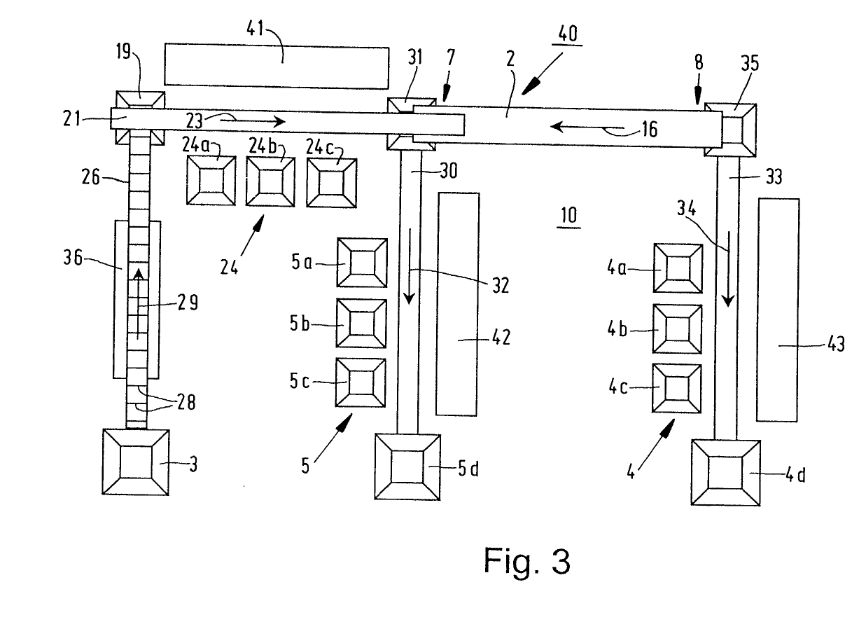

FIG. 3 schematically shows in top plan view an alternative arrangement 40 of the apparatus 30 as shown in FIG. 2. Also in this case it obtains that the same parts, or parts having a similar operation or function as described with reference to FIGS. 1 and 2, are indicated by the same numerals in FIG. 3.

As appears from FIG. 3, pre-sorting conveyor belt 21 and sloping conveyor belt 2 are arranged in line, whilst Jacob's ladder 26, first re-sorting conveyor belt 30 and second re-sorting conveyor belt 33 are disposed at right angles to the pre-sorting conveyor belt 21 and the sloping conveyor belt 2.

As a result the elevated position of conveyor belts 21, 30 and 33, platforms 41, 42 and 43 adjoin said belts, on which platforms examiners can take up position for the purpose of examining and manually identifying (“picking”) and sorting, possibly with the use of auxiliary means, specific types of batteries from the collected batteries that are being supplied.

Pre-sorting conveyor belt 21 can also be used for determining whether a collected batch is at all suitable for being sorted by apparatus 40. A batch is unsuitable, for example, if the various batteries and other objects stick together, or if they are soiled to such an extent, for example by ink from disposed printer cartridges, that recognition is no longer possible.

In one practical embodiment, pre-sorting conveyor belt 21 has a length of about 12 m and a width of 0.5 m, while being positioned at a height of about 4.5 m from the workshop floor 10. Sloping conveyor belt 2 has a length of about 6 m and a width of about 0.8 m, whereby the mixture of batteries lands from the pre-sorting conveyor belt 21 onto the sloping conveyor belt 2 from a height of about 50 cm. The first (or upper) re-sorting conveyor belt 30 has a length of about 6 m, whilst the second (or lower) re-sorting conveyor belt 31 has a length of about 8 m.

The preferred embodiment of the sorting apparatus 20 or 40 according to the invention enables very efficient and high-quality sorting of used batteries according to their type and their electrochemical system, wherein foreign matter in the form of objects such as medical waste, coins, cosmetics, capacitors, ink cartridges, printer cartridges, watches, mixers, nails, ammunition and packaged batteries and batteries in bags or boxes may be present among the collected, used batteries. The used batteries can be sorted in a very accurate manner, thus enabling purposive and economically sound recycling.

Since the apparatus according to the invention does not require the use of detection equipment, which is liable to malfunction, and since the collected, used batteries are not subjected to jolts, impacts or similar mechanical activities, the risk of batteries exploding is very small, so that the apparatus is safe to use. The apparatus is furthermore constructed in such a manner that fire fighting means can be provided at various locations, such as sand hoppers, spades etc. so as to make it possible to fight fire or other calamities at an early stage. Since dust and other harmful substances are discharged at an early stage already, the pre-sorting and re-sorting steps can be carried out manually by human examiners.

1. Apparatus for sorting used batteries, comprising an intake station, an outlet station and a pre-sorting station disposed between said intake station and said outlet station, said pre-sorting station connects to a first re-sorting station, said pre-sorting station furthermore connects to a second re-sorting station, wherein the two re-sorting stations are arranged for the manual examination and removal of undesirable batteries and further objects, as well as for the manual sorting of batteries and other objects that land in said re-sorting stations during operation.

2. Apparatus according to claim 1, wherein said pre-sorting station comprises a sloping conveyor belt having a conveying surface which moves from a lower end to an upper end during operation for the purpose of sorting batteries under the influence of the force of gravity, wherein said upper end of the sloping conveyor belt connects to said first re-sorting station which comprises a first re-sorting conveyor belt, and wherein said lower end of the sloping conveyor belt connects to said second re-sorting station which comprises a second re-sorting conveyor belt, which re-sorting conveyor belts are arranged for the manual examination and removal of undesirable batteries and further objects, as well as for the manual sorting of batteries and further objects that land on said re-sorting conveyor belts during operation.

3. Apparatus according to claim 2, wherein said sloping conveyor belt is disposed at an angle of 15-35 degrees to a horizontal plane.

4. Apparatus according to claim 3, wherein said angle is essentially 21.5 degrees.

5. Apparatus according to claim 2, wherein said sloping conveyor belt moves at a velocity of about 0.6-1 m/sec during sorting operation.

6. Apparatus according to claim 5, wherein the velocity is essentially 0.8 m/sec.

7. Apparatus according to claim 2, wherein the conveying surface of said sloping conveyor belt has a “Rufftop” profile.

8. Apparatus according to claim 2, wherein the conveying surface of the sloping conveyor belt is made of laminated, reinforced polyester.

9. Apparatus according to claim 1, wherein a re-screening separator is disposed between said pre-sorting station and said first re-sorting station.

10. Apparatus according to claim 1, wherein said outlet station comprises a first sub-outlet station, to which said first re-sorting station connects, and a second sub-outlet station, to which said second re-sorting station connects.

11. Apparatus according to claim 2, wherein said pre-sorting station comprises a pre-sorting conveyor belt disposed between said intake station and said sloping conveyor belt, which pre-sorting conveyor belt is arranged for manual examination and removal of undesirable batteries and further objects that land on the pre-sorting conveyor belt during operation.

12. Apparatus according to claim 11, wherein said pre-sorting conveyor belt discharges onto said sloping conveyor belt near the upper end thereof.

13. Apparatus according to claim 12, wherein said pre-sorting conveyor belt essentially connects to said sloping conveyor belt at about ¼ the length of said sloping conveyor belt, seen from the upper end thereof.

14. Apparatus according to claim 2, wherein at least one of said pre-sorting and re-sorting conveyor belts is provided with means for automatic examination or sampling of fractions batteries and further objects that are present on a respective conveyor belt.

15. Apparatus according to claim 11, wherein said outlet station comprises a third sub-outlet station, which connects to said pre-sorting conveyor belt.

16. Apparatus according to claim 2, wherein said re-sorting conveyor belts and said pre-sorting conveyor belt are made of a smooth plastic material.

17. Apparatus according to claim 16, wherein said sorting conveyor belts are made of PVC material.

18. Apparatus according to claim 11, wherein said pre-sorting conveyor belt, said sloping conveyor belt and said first and said second re-sorting conveyor belt are arranged at a level some distance above a workshop floor.

19. Apparatus according to claim 18, wherein said level has been so selected that it is possible to place removable collecting containers under said sub-outlet stations for the purpose of collecting removed and sorted batteries and other objects therein.

20. Apparatus according to claim 18, wherein said intake station is disposed on said workshop floor, and wherein a so-called Jacob's ladder is installed between said intake station and said pre-sorting conveyor belt for transporting batteries being supplied from said intake station to said pre-sorting station.

21. Apparatus according to claim 20, wherein said Jacob's ladder consists of a conveyor belt with an accordion belt on its sides, in which vertical partitions are provided for moving said batteries to said pre-sorting conveyor belt in metered amounts.

22. Apparatus according to claim 21, wherein said partitions are adjustable.

23. Apparatus according to claim 21, wherein said conveyor belt of said Jacob's ladder connects to a collecting container, which functions to receive foreign matter adhering to said conveyor belt during return movement thereof.

24. Method for sorting used batteries by means of an apparatus comprising an intake station, an outlet station and a pre-sorting station disposed between said intake station and said outlet station, said pre-sorting station connects to a first re-sorting station, said pre-sorting station furthermore connects to a second re-sorting station, wherein batteries and further objects that land in said re-sorting stations during operation are examined, wherein undesirable batteries and said further objects are manually removed and wherein other batteries that land in said re-sorting stations are manually sorted.

25. Method according to claim 25, wherein said pre-sorting station comprises a pre-sorting conveyor belt, wherein undesirable batteries and further objects that land on said pre-sorting conveyor belt during operation are manually examined and removed.
